(19) United States
(12) Patent Application Publication
(10) Pub. No.: US 2006/0040751 A1
(43) Pub. Date: Feb. 23, 2006

(54) Protective boot

(76) Inventor: Wolfgang Wittenbecher, Gumperda (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/534,664

(22) PCT Filed: Nov. 7, 2003
(86) PCT No.: PCT/DE03/03722

§ 371 Date: May 10, 2005

(30) Foreign Application Priority Data
Nov. 11, 2002 (DE) 102 53 059.9

(51) Int. Cl. F16D 3/84

(52) U.S. Cl. 464/175

(57) ABSTRACT

Protective boot comprising bellows and a bushing, in particular for power transmission systems in a vehicle. The bellows and the bushing are so constructed and connected to one another that their connection remains tight independent of loading and long-term influences.

### CROSS-REFERENCE TO RELATED APPLICATIONS

This application claims priority of International Application No. PCT/DE2003/003722, filed Nov. 7, 2003 and German Application No. 102 53 059.9, filed Nov. 11, 2002, the complete disclosures of which are hereby incorporated by reference.

### BACKGROUND OF THE INVENTION

a) Field of the Invention

The present invention is directed to a protective boot comprising bellows and a bushing, in particular for power transmission systems in a vehicle.

b) Description of the Related Art

The object of protective boots of the type mentioned above is, on the one hand, to prevent outside dust, water, and the like from penetrating into the structural component part to be protected, generally an articulated part, and, on the other hand, to preserve over a long period an amount of lubricant that may be located around the structural component part.

The particular mechanical and thermal loads to which a protective boot of this kind is exposed over the years and changes in the material thereof resulting from aging impose high demands on a durable and necessarily tight connection between the bellows and the bushing that is suitable for these loads. On the other hand, the connection technique must be economically efficient and suitable for large-scale production.

Very often, protective boots comprise bellows whose ends are constructed as cylindrical bellows portions having an inner diameter that is determined by the outer diameter of the structural component part enclosed by it. In many cases, this structural component part is a bushing that forms a connection member between the bellows and the structural component part to be protected.

Both the bellows and a bushing of the type mentioned above are usually made of a black, flexible plastic which should not become brittle even under great fluctuations in temperature and under extreme mechanical loading by permanent deformation due to compression and bending. The bushing is generally manufactured with a slightly larger outer diameter than the inner diameter of the bellows portion and with the bellows portion inserted therein in an expanded state. Accordingly, the bellows is fitted on the bushing in a pretensioned and taught manner. Usually, this frictional engagement is reinforced and secured by a tensioning strip enclosing the outer circumference of the bellows portion. The quality of the connection has no bearing on whether the tensioning strip is placed around the protective boot before mounting on the structural component part to be protected, e.g., an articulated shaft, or after mounting. The bellows are fixed on the circumference of the structural component part indirectly by the bushing when the tensioning strip is tightened.

However, this squeezing connection offers no guarantee of tightness over the long term. The high loads and natural aging process can lead to changes in the material such as shrinkage and embrittlement. As a result, the connection could become permeable.

The inner contour (inner surface) of the bushing is not important as regards the connection between the bellows and bushing and is determined exclusively by the structural shape of the component part to which the protective boot is to be connected.

### OBJECT AND SUMMARY OF THE INVENTION

It is the primary object of the invention to alter a protective boot comprising bellows and a bushing in such a way that long-term tightness is ensured.

This object is met according to the invention by a protective boot comprising bellows which terminate in a cylindrical bellows portion in which a bushing is fitted; the bushing having an outer diameter being at least equal to the inner diameter of the bellows portion. The bushing comprises a material that is substantially transparent for a wavelength suitable for laser welding. The bellows comprises a material that acts substantially absorbently. The bushing and the bellows are materially connected by a laser-welded connection.

Further in accordance with the invention, a protective boot comprises bellows which terminate in a cylindrical bellows portion in which a bushing is fitted; the bushing having an outer diameter being at least equal to the inner diameter of the bellows portion. The bellows comprises a material that is substantially transparent for a wavelength suitable for laser welding. The bushing comprises a material that acts substantially absorbently. The bushing and the bellows are materially connected by a laser-welded connection.

The invention will be described more fully in the following with reference to four embodiment examples shown in the drawings.

### BRIEF DESCRIPTION OF THE DRAWINGS

In the drawings:

FIG. 1 shows a top view of a protective boot with tensioning strip;

FIG. 2 shows a first special construction of a bushing; and

FIG. 3 shows a second special construction of a bushing.

### DESCRIPTION OF THE PREFERRED EMBODIMENTS

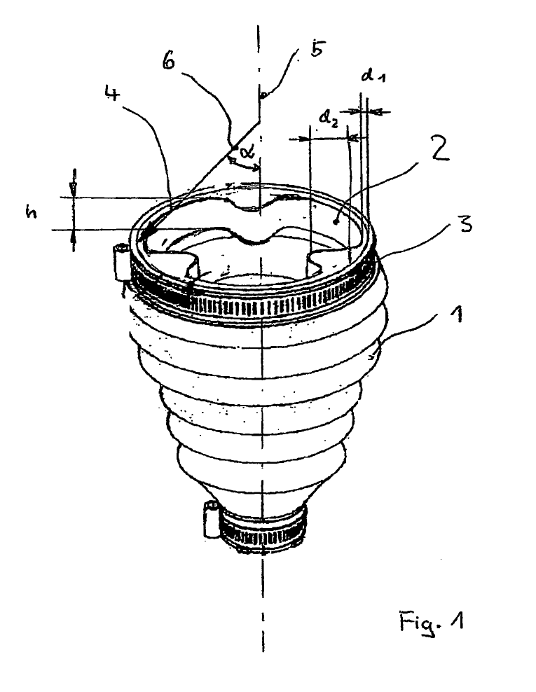

FIG. 1 shows a protective boot comprising bellows 1 and a bushing 2 surrounded by a tensioning strip 3. A cylindrical bellows portion is formed respectively at the two ends of the bellows 1. The bushing 2 is fitted into one of these two bellows portions. The outer diameter of the bushing is equal to or slightly larger than the inner diameter of the bellows portion. The inner contour of the bushing 2, in the present case three projections which are offset by 120% with respect to one another, extends along the height h of the bushing 2 so that the thickness d of the bushing 2 assumes values over its circumference between a minimum thickness d and a maximum thickness d₂. The thickness d₁ of the bushing 2 is not constant in any plane of a circumferential line. Accordingly, this bushing geometry corresponds to a bushing known from the prior art.

The first embodiment example and the following two embodiment examples differ from one another with respect to the geometric construction of the bushing.

In contrast to the prior art, however, the bushing 2 is made of a material which is transparent for a wavelength suitable for laser welding (e.g., 808 nm or 940 nm). In order to produce a weld connection of uniform quality over the circumference of the bushing 2, the beam path through the bushing 2 should be at least approximately equal along the circumference. In a bushing such as that shown in FIG. 1, a laser beam bundle 6 directed to the bushing 2 along a circular line has an approximately equal path through the material of the bushing 2 when it is directed at an angle, e.g., 45°, to the axis of symmetry 5 of the protective boot on the edge 4 thereof. The laser beam penetrates the radiation-transparent bushing 2 and impinges on the absorbent material of the bellows 1. The material of the bellows 1 is heated, the heat is conducted to the bushing 2 by mechanical contact, and both parts are melted at their contacting surfaces. A circular, invisible weld is formed between the bushing 2 and the bellows 1 in that the laser beam 6 and the protective boot execute a rotating relative movement with respect to one another around the axis of symmetry 5. The same plastic, which is fundamentally transparent for the laser radiation 6, is advantageously used for the bellows 1 and the bushing 2. Additions such as carbon black are mixed in so that the laser radiation 6 can be absorbed. The advantage to using identical plastics for the two parts consists not only in that the long-term behavior determined by changes in the material characteristics is the same, but also in particular that both parts then have the same melting temperature.

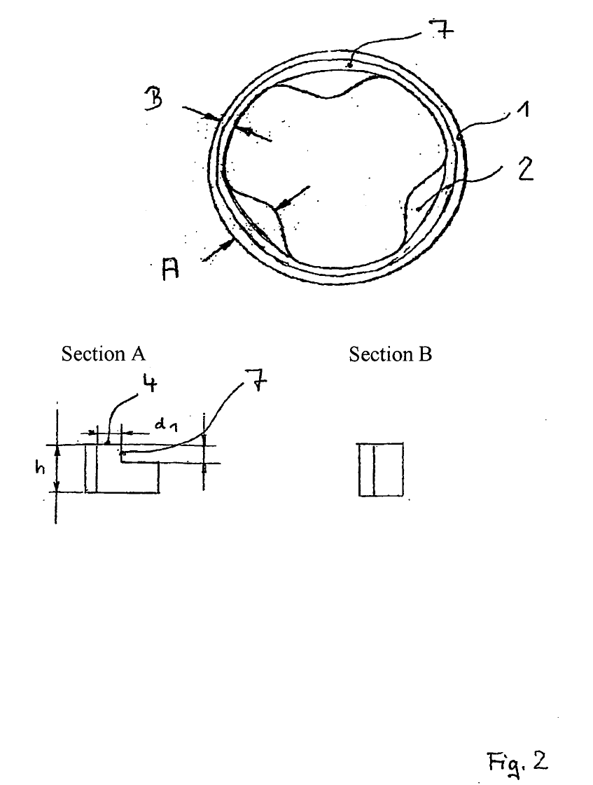

In a second embodiment example shown in FIG. 2, the bushing 2 that is fitted into the bellows 1 has a different inner contour than that in the first embodiment example. The functionally determined geometry is limited in this case to an area of the inner surface smaller than the height h, wherein the edge 4 defines a collar 7 having a constant thickness d over its entire circumference. Ideally, thickness d is equal to the minimum thickness d₁. This results in more favorable conditions for coupling in the laser beam. The angle may be greater by up to 90° so that the laser beam impinges perpendicularly on the surface of the bushing 2 and on the contact surface between the bushing 2 and the bellows 1.

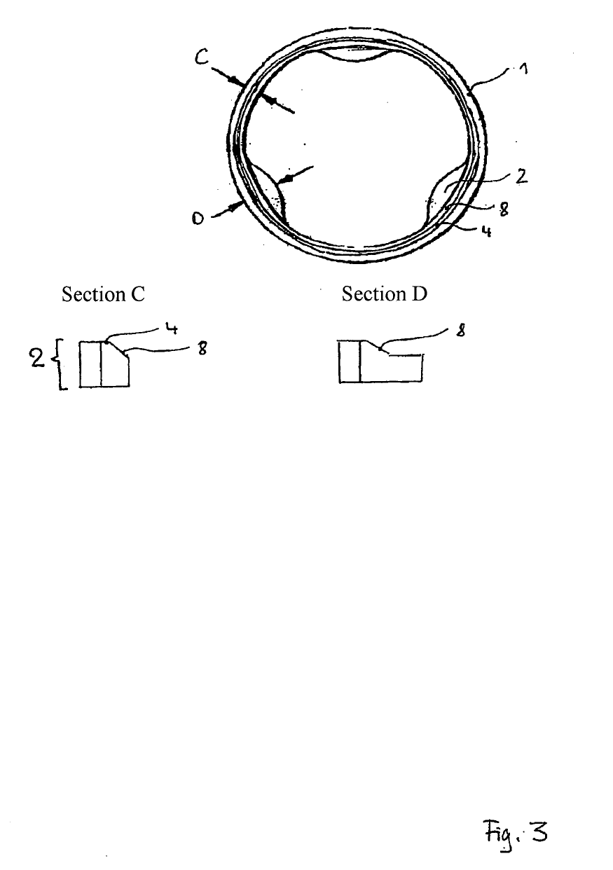

In a third embodiment example shown in FIG. 3, a bevel 8 is provided adjoining the edge 4 instead of the collar 7. In contrast to the first embodiment example, in which the laser beam 6 impinges at an angle on the surface of the bushing 2 and on the contact surface between the bushing 2 and the bellows 1, the laser beam 6 can be coupled into the bushing 2 perpendicularly by means of the bevel 8 so that, in particular, radiation losses due to reflection are prevented.

In a fourth embodiment example, the bushing 2 is made of a material that absorbs the laser radiation and the bellows 1 is transparent for the laser beam 6 at least in the area of the cylindrical bellows portion. Accordingly, the laser beam 6 is coupled into the bushing 2 via the bellows 1. A solution of this kind has the advantage that the geometry of the bushing 2, except for the outer surface, can be carried out in any way, i.e., a device provided for this purpose can be used for bushings 2 with a wide variety of inner contours. As in the second embodiment example, the laser beam 6 can ideally be coupled into the surface of the bellows 1 and into the contact surface between the bellows 1 and the bushing 2 perpendicularly. In this embodiment example, the tensioning strip 3 can be mounted after producing the weld connection.

The person skilled in the art will appreciate that the laser output can be introduced with or without control. The temperature in the melting zone could serve as an actuating variable and also to verify a secure weld connection.

While the foregoing description and drawings represent the present invention, it will be obvious to those skilled in the art that various changes may be made therein without departing from the true spirit and scope of the present invention.

1-8. (canceled)

9. A protective boot comprising:
bellows which terminate in a cylindrical bellows portion in which a bushing is fitted;
said bushing having an outer diameter being at least equal to the inner diameter of the bellows portion;
said bushing comprising a material that is substantially transparent for a wavelength suitable for laser welding;
said bellows comprising a material that acts substantially absorbently; and
said bushing and said bellows being materially connected by a laser-welded connection.

10. A protective boot comprising:
bellows which terminate in a cylindrical bellows portion in which a bushing is fitted;
said bushing having an outer diameter being at least equal to the inner diameter of the bellows portion;
said bellows comprising a material that is substantially transparent for a wavelength suitable for laser welding;
said bushing comprising a material that acts substantially absorbently; and
said bushing and said bellows being materially connected by a laser-welded connection.

11. The protective boot according to claim 9, wherein the bellows and the bushing are made from the same thermoplastic in which carbon black particles are mixed in only for the bellows.

12. The protective boot according to claim 10, wherein the bellows and the bushing are made from the same thermoplastic in which carbon black particles are mixed in only for the bushing.

13. The protective boot according to claim 9, wherein the bushing has an area in which it has a constant wall thickness along its circumferential lines.

14. The protective boot according to claim 13, wherein the inner diameter of the bushing is constant along the aforementioned area in which a collar is formed.

15. The protective boot according to claim 13, wherein the inner diameter of the bushing is adapted continuously to the outer diameter along the aforementioned area in which a bevel is formed.

16. The protective boot according to claim 9, wherein the bellows is made of Hytrel 8223 and the bushing is made of Hytrel 5526.
